(19) United States
(12) Patent Application Publication
(10) Pub. No.: US 2026/0368133 A1
(43) Pub. Date: Nov. 19, 2026

(54) Implementing checkpoint sharing in a reconfigurable processor

(71) Applicant: SambaNova Systems, Inc., Palo Alto, CA (US)

(72) Inventors: Joshua BROT, Palo Alto, CA (US); Weifeng Han, Palo Alto, CA (US)

(73) Assignee: SambaNova Systems, Inc., Palo Alto, CA (US)

(21) Appl. No.: 19/297,526

(22) Filed: Aug. 12, 2025

Related U.S. Application Data
(60) Provisional application No. 63/808,172, filed on May 19, 2025.

(51) Int. Cl. G06F 15/78

(52) U.S. Cl. CPC G06F 15/7885

(57) ABSTRACT

A data processing system includes reconfigurable processor circuits coupled to memory circuitry and a runtime processor that is coupled to the reconfigurable processor circuits and the memory circuitry. The runtime processor is configured to receive first and second configuration files of respective first and second configurations of an application, and to configure first and second reconfigurable components in the reconfigurable processor circuits according to the first and second configurations, respectively. The first reconfigurable components are being configured to access the memory circuitry to retrieve a shared set of weights that is stored in the memory circuitry and implement a first set of operations that operates on the shared set of weights. The second reconfigurable components are being configured to access the memory circuitry to retrieve the shared set of weights, and implement a second set of operations that operates on the shared set of weights.

### REFERENCES

This application claims the benefit of U.S. Provisional Patent Application No. 63/808,172, entitled, “Implementing Checkpoint Sharing in a Reconfigurable Processor” filed on 19 May 2025. The provisional application is hereby incorporated by reference for all purposes.

The following are incorporated by reference for all purposes:
Prabhakar et al., “Plasticine: A Reconfigurable Architecture for Parallel Patterns,” ISCA '17, June 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018; and

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to the execution of a Large Language Model (LLM) in reconfigurable processor circuits. In particular, it relates to checkpoint sharing between different configurations of an LLM during the execution of that LLM in reconfigurable processor circuits.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

A Large Language Model (LLM) consists of a sequence of operations. Each operation in the sequence of operations takes as input two tensors of numbers, one of which is called the “activation” and one of which is hardcoded, called the “weight.” The output of each operation becomes the activation for the next operation. The initial input to the first operation of the sequence of operations of the LLM is user provided text, which is sometimes also referred to as the “prompt”. The output from the last operation of the sequence of operations of the LLM is a prediction for the next few characters in the provided text.

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused-control memory unit (FCMU).

FIG. 6 illustrates a data processing system in which applications are implemented on reconfigurable processors.

FIG. 7 illustrates an implementation of a configuration file used by the technology disclosed to configure reconfigurable processors according to a configuration that is based on a processing graph of an application.

FIG. 8 illustrates an example flowchart of illustrative operations that a runtime processor performs for implementing checkpoint sharing when programming reconfigurable components of reconfigurable processors.

FIG. 9 illustrates an example method of operating a data processing system comprising a runtime processor that is coupled to reconfigurable processor circuits and memory circuitry.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope as claimed. Instead, they merely represent examples of different implementations.

### DETAILED DESCRIPTION

Deep learning is a subset of machine learning algorithms that are inspired by the structure and function of the human brain. Most deep learning algorithms involve artificial neural network architectures, in which multiple layers of neurons each receive input from neurons in a prior layer or layers, and in turn influence the neurons in the subsequent layer or layers. Training these neural network models can be computationally extremely demanding.

As machine learning based technologies are more widely deployed, it is becoming important to implement them at low cost using flexible hardware architectures. In such architectures, including integrated circuit components, area, and power consumption are critical design parameters. One class of integrated circuits includes reconfigurable processor integrated circuits, which are sometimes also simply referred to as reconfigurable processors.

Reconfigurable processors can be configured to implement a variety of functions. In particular, so-called Coarse-Grained Reconfigurable Architectures (CGRAs) are being developed in which the configurable units in the array are complex and that may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada. Various aspects of some of such CGRAs are described in the above-incorporated patent applications.

A CGRA typically includes an array of reconfigurable units and operate on streams of data and control messages that flow through a sea of these reconfigurable units, sometimes referred to herein as Coarse-Grained Reconfigurable Units (CGRUs). The units can comprise somewhat specialized computational and memory units.

As mentioned above, a Large Language Model (LLM) consists of a sequence of operations. Each operation takes as input two tensors of numbers, one of which is called the “activation” and one of which is hardcoded and stored in memory circuitry, called the “weight.” The output of each operation becomes the activation for the next operation. The prompt (i.e., the initial input to first operation of the sequence of operations of the LLM) corresponds to user provided text while the last output from the LLM is a prediction for the next few characters in the provided text.

The set of all weights is collectively called a “checkpoint.” There are often hundreds of individual weights in a checkpoint and the total size of the checkpoint ranges from a few hundred megabytes (MB) to over a tera byte (TB).

For executing an LLM on a reconfigurable processor circuit, the reconfigurable processor circuit is configured with an LLM configuration. For this purpose, a compiler generates a configuration file, which is sometimes also referred to as a “processor-executable file (PEF)”. The configuration file includes data related to settings, parameters, or directives such that the reconfigurable processor circuit that is configured with the data in the configuration file implements the various operations of the sequence of operations that constitute the LLM. The data in the configuration file is also related to the set of weights (checkpoint) of the LLM. After configuration of a reconfigurable processor circuit with the configuration file and storage of the weights that form the checkpoint in associated memory circuitry, the reconfigurable processor circuit can repeatedly execute the LLM on different inputs.

For a given set of weights, the compiler can generate many different configuration files for a same LLM, whereby configuration of the reconfigurable processor circuit with the different configuration files implement trade-offs between various performance characteristics such as throughput, latency, and number of concurrent users served, just to name a few. Therefore, it's often desirable that a compiler generates several different configuration files for each checkpoint, whereby the different configuration files can adapt to current user requests. Typically, each configuration file is associated with its own copy of the checkpoint. However, having each configuration file associated with its own copy of the checkpoint becomes prohibitive for larger checkpoints.

In some implementations, a compiler can generate different configuration files such that the respective configured reconfigurable processor circuits share a same checkpoint. Checkpoint sharing allows for a same copy of the checkpoint in memory to be used by reconfigurable processor circuits that are configured with these different configuration files. In these implementations, it is desirable that a runtime processor that is coupled to the reconfigurable processor circuits and memory circuitry and that manages resource allocation, memory mapping, and execution of the configuration files on the reconfigurable processor circuits and memory circuitry can efficiently implement checkpoint sharing on the reconfigurable processor circuits and the memory circuitry.

The technology disclosed herein provides such systems and methods, configuring reconfigurable components in reconfigurable processor circuits according to different configurations such that the configured reconfigurable components access memory circuitry that is coupled to the reconfigurable processor circuits to retrieve a same shared set of weights.

The disclosed technology resolves this by providing reconfigurable processor circuits, memory circuitry that is couple to the reconfigurable processor circuits, and a runtime processor that is coupled to the reconfigurable processor circuits and the memory circuitry, wherein the runtime processor is configured to: receive a first configuration file of a first configuration of an application, receive a second configuration file of a second configuration of the application, wherein the second configuration is different than the first configuration, configure first reconfigurable components in the reconfigurable processor circuits according to the first configuration, the first reconfigurable components being configured to access the memory circuitry to retrieve a shared set of weights that is stored in the memory circuitry, and implement a first set of operations that operates on the shared set of weights; and configure second reconfigurable components in the reconfigurable processor circuits according to the second configuration, the second reconfigurable components being configured to access the memory circuitry to retrieve the shared set of weights, and implement a second set of operations that operates on the shared set of weights.

The second reconfigurable components can be the same as the first reconfigurable components or different from the first reconfigurable components. If desired, a subset of the second reconfigurable components can be shared with the first reconfigurable components, or a subset of the first reconfigurable components can be shared with the second reconfigurable components.

The shared portion of the first and second reconfigurable components implements either one of the first or second configuration at a given point in time. In other words, at a time T1, the shared portion of the first and second reconfigurable components can implement the first configuration but not the second configuration, and at a different time T2, the shared portion of the first and second reconfigurable components can implement the second configuration but not the first configuration.

### Terminology

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

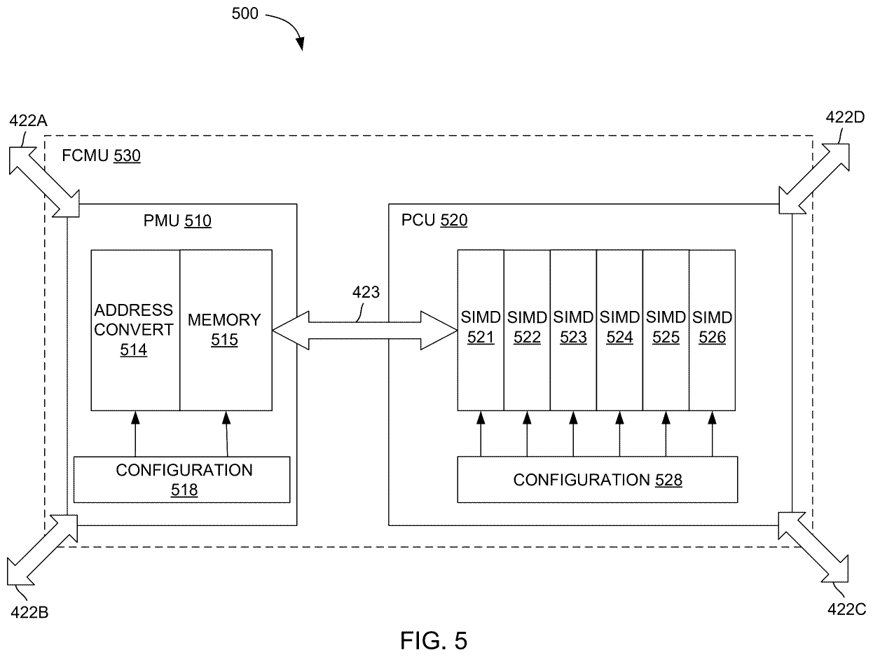

The following terms or acronyms used herein are defined at least in part as follows:
Activation—output of an operation that is the input to a next operation in a sequence of operations that form a large language model (LLM).
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
CGR Array—an array of CGR units, coupled with each other through an array-level network (ALN), and coupled with external elements via a top-level network (TLN). A CGR array can physically implement the nodes and edges of a dataflow graph.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in processing graphs and dataflow graphs. Further examples of CGR units include a CU and an AG, which may be combined in an AGCU. Some implementations include CGR switches, whereas other implementations may include regular switches.
Checkpoint—a set of weights in a large language model (LLM).
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.
Processing graph—some algorithms can be represented as processing graphs. As used herein, processing graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the processing graph reveals which operations and/or expressions can be executed concurrently.
CU—coalescing unit.
Data Flow Graph—a processing graph that includes one or more loops that may be nested, and wherein nodes can send messages to nodes in earlier layers to control the dataflow between the layers.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
FSM—finite state machine.
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
LLM—large language model.
LUT—lookup table.
ML—machine learning.
PCU—pattern compute unit—a compute unit that can be configured to repetitively perform a sequence of operations.
PE—Power estimator.
PICN—Power information and control network.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a meta-pipeline at the graph execution level (typically a sequence of logical operations that are to be repetitively executed) that enables correct timing and loop control of node-level operations of the configured graph. Gate-level pipelines are usually hard wired and unchangeable, whereas meta-pipelines are configured at the CGR processor, CGR array level, and/or GCR unit level.
Pipeline Stages—a pipeline is divided into stages that are coupled with one another to form a pipe topology.
Prompt—input to an LLM.
PMU—pattern memory unit—a memory unit that can locally store data according to a programmed pattern.
SIMD—single-instruction multiple-data—an arithmetic logic unit (ALU) that simultaneously performs a single programmable operation on multiple data elements delivering multiple output results.
TLN—top-level network.
Weights—numerical values in an LLM that are adjusted during the training process to optimize the LLM's ability to generate coherent and relevant text and that are stored in memory circuitry during execution of the LLM during which they are combined with the activation during the execution of a sequence of operations.

### Implementations

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

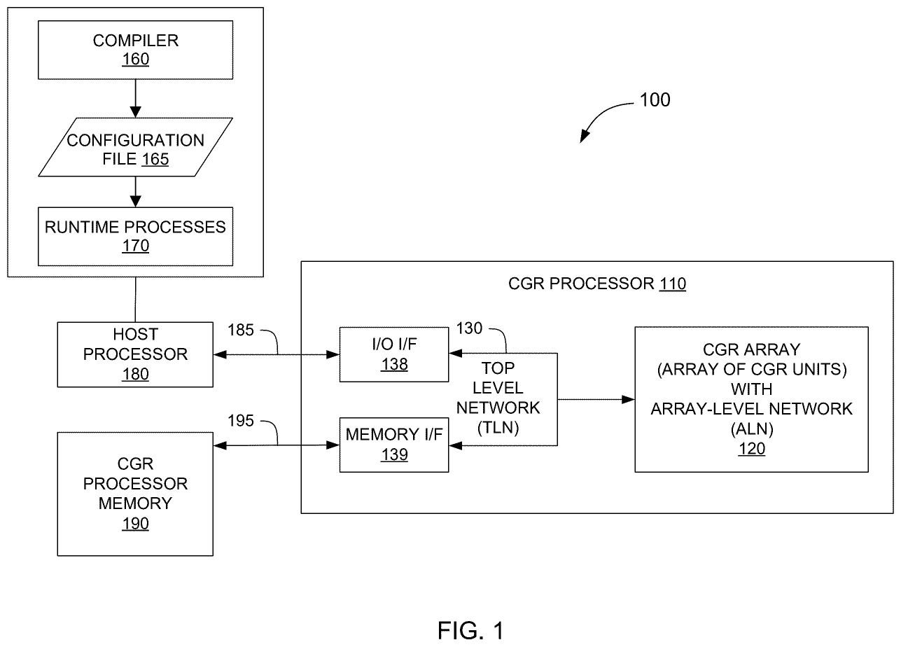

FIG. 1 illustrates an example system 100 including a host 180, a memory 190, and a reconfigurable processor circuit such as a CGR processor 110. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via databus 130 which may be part of a top-level network (TLN). Host 180 communicates with IO interface 138 via system databus 185, and memory interface 139 communicates with memory 190 via memory bus 195. Array of CGR units 120 may further include compute units and memory units that are connected with an array-level network (ALN) to provide the circuitry for execution of a processing graph or a dataflow graph that may have been derived from a high-level program with user algorithms and functions. The high-level program may include a set of procedures, such as learning or inferencing in an LLM, AI, or ML system. More specifically, the high-level program may include applications, graphs, application graphs, user applications, processing graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

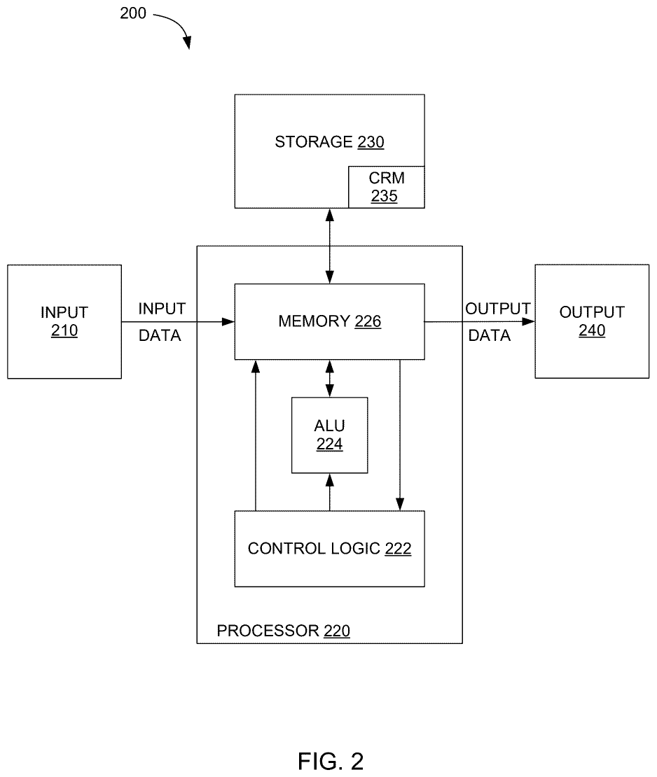

Host 180 may be, or include, a computer such as further described with reference to FIG. 2. Host 180 runs runtime processes, as further referenced herein, and may also be used to run computer programs, such as the compiler 160. In some implementations, the compiler 160 may run on a computer that is similar to the computer described with reference to FIG. 2, but separate from host 180.

CGR processor 110 may accomplish computational tasks by executing a configuration file 165. For the purposes of this description, a configuration file corresponds to a dataflow graph, or a translation of a dataflow graph, and may further include initialization data and/or instructions or directives for storing data in and/or retrieving data from memory circuitry according to a shareable layout.

A compiler 160 compiles the high-level program to provide the configuration file 165. Runtime processes 170 may install the configuration file 165 in CGR processor 110. In some implementations described herein, a CGR array 120 is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the processing graph to the CGR array 120. Execution of the configuration file by CGR processor 110 causes the CGR array 120 to implement the user algorithms and functions in the dataflow graph. If desired, execution of the configuration file by CGR processor 110 causes the CGR array 120 to store data in CGR processor memory 190 according to a shareable layout and/or retrieve stored data from the CGR processor memory 190 according to the shareable layout

CGR processor 110 can be implemented on a single integrated circuit (IC) die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

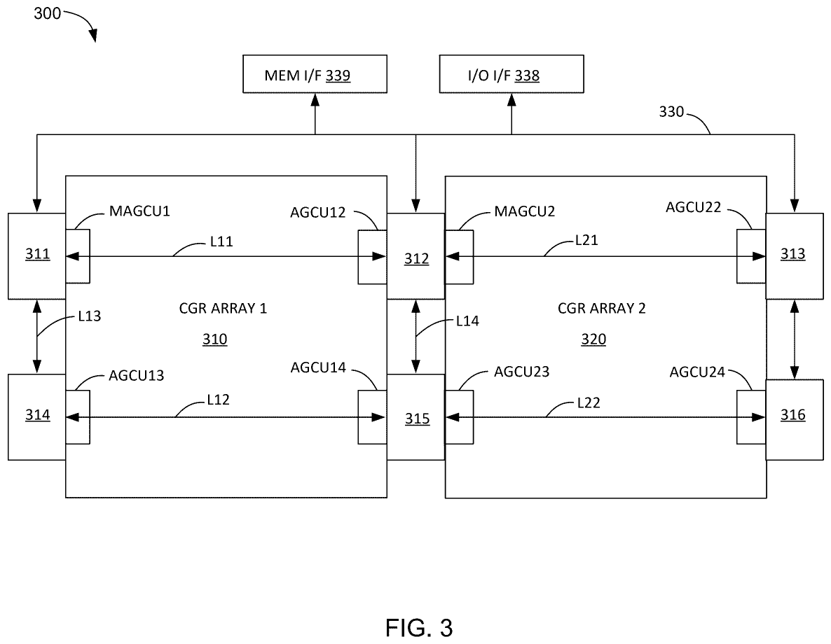

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., a master AGCU (MAGCU) labeled MAGCU1, and three other AGCUs labeled AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, external I/O interface 338, and external memory interface 339. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

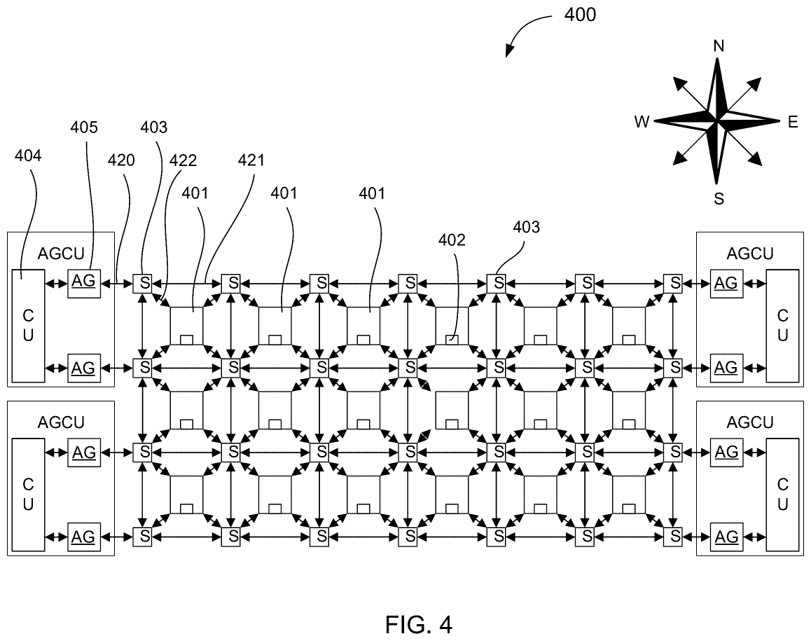

FIG. 4 illustrates an example CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017, Jun. 24-28, 2017, Toronto, ON, Canada. Each of the CGR units may include a configuration store 402 comprising a set of registers or flip-flops storing configuration data from a configuration file that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

As shown in FIG. 4, a CGR unit 401 may have four ports to interface with switch units 403, or any other number of ports suitable for an ALN. Each port may be suitable for receiving and transmitting data, or a port may be suitable for only receiving or only transmitting data.

A switch unit 403, as shown in the example of FIG. 4, may have eight interfaces. The North, South, East and West interfaces of a switch unit 403 may be used for links between switch units using interconnects 421. The Northeast, Southeast, Northwest and Southwest interfaces of a switch unit 403 may each be used to make a link with an FCMU, PCU or PMU instance using one of the interconnects 422. Two switch units 403 in each CGR array quadrant have links to an AGCU using interconnects 420. The AGCU coalescing unit 404 arbitrates between the AGs 405 and processes memory requests. Each of the eight interfaces of a switch unit 403 can include a vector interface, a scalar interface, and a control interface to communicate with the vector network, the scalar network, and the control network. In other implementations, a switch unit 403 may have any number of interfaces.

During execution of a graph or subgraph in a CGR array after configuration, data can be sent via one or more switch units 403 and one or more links between the switch units 403 to the CGR units 401 using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations (e.g., from a sequence of operations that constitute an LLM) that are distributed among and executed by corresponding CGR units (e.g., FCMUs, PMUs, PCUs) as well as AGs, and CUs.

FIG. 5 illustrates an example 500 of a PMU 510 and a PCU 520, which may be combined in an FCMU 530. PMU 510 may be directly coupled to PCU 520, or optionally via one or more switches. PMU 510 includes a scratchpad memory 515, which may receive external data, memory addresses, and memory control information (e.g., write enable, read enable, etc.) via one or more buses included in the ALN. PCU 520 includes two or more processor stages, such as SIMD 521 through SIMD 526, and configuration store 528. The processor stages may include ALUs, or SIMDs, as drawn, or any other reconfigurable data processing stages.

Each stage in PCU 520 may also hold one or more registers (not shown) for short-term storage of parameters. Short-term storage, for example during one to several clock cycles or unit delays, allows for synchronization of data in the PCU pipeline.

### Implementing Checkpoint Sharing in Reconfigurable Processor Circuits

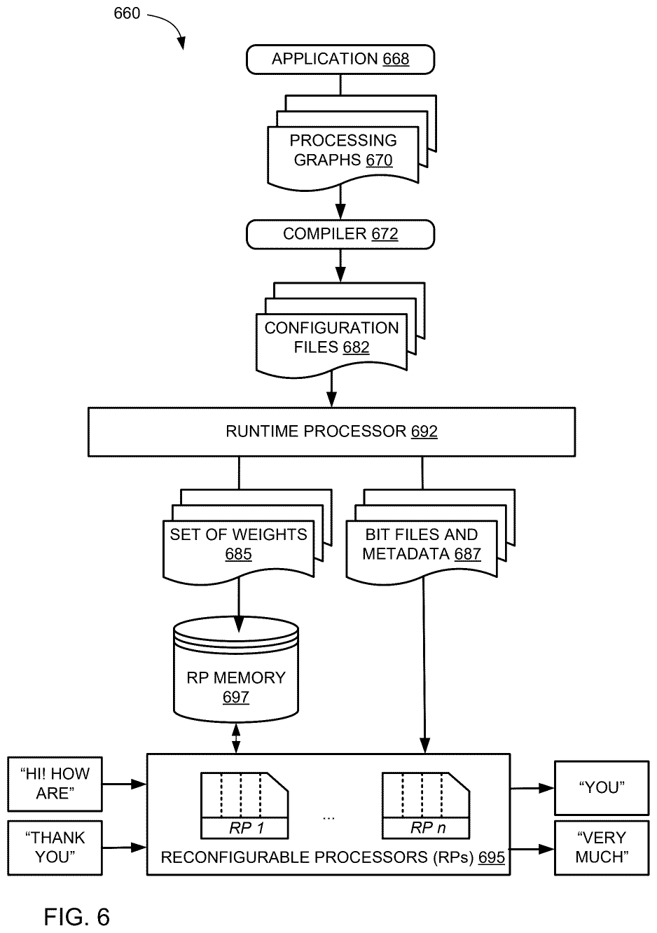

FIG. 6 shows a data processing system 660 that provides on-demand network access to reconfigurable processors circuits 695 RP 1 to RP n, which are sometimes also simply referred to as reconfigurable processors 695. The reconfigurable processor circuits 695 can be rapidly provisioned and released with minimal management effort or service provider interaction. A reconfigurable processor of the reconfigurable processors 695 includes reconfigurable components (e.g., compute units 520 and memory units 510 of FIG. 5). The reconfigurable components can be arranged in arrays of coarse-grained reconfigurable (CGR) units (e.g., array of CGR units 120 of FIG. 1). The arrays of CGR units may be embedded in a programmable interconnect fabric (e.g., array-level network 120 of FIG. 1). The arrays of CGR units in a reconfigurable processor can be partitionable into a plurality of subsets (or tiles) of arrays of CGR units.

Bus (or transfer) resources interconnect the reconfigurable processors 695 and enable the reconfigurable processors 695 to receive and send data. Examples of the bus resources include PCIe channels, DMA channels, and DDR channels. The reconfigurable processors 695 are coupled to memory (or storage) circuitry such as reconfigurable processor (RP) memory 697 usable to store data. The reconfigurable components in the reconfigurable processors 695 are configured to access the memory circuitry via a DDR interface or a high-bandwidth memory (HBM) interface, if desired. Examples of the memory circuitry include main memory (e.g., off-chip/external DRAM), local secondary storage (e.g., local disks (e.g., HDD, SSD)), and remote secondary storage (e.g., distributed file systems, web servers). Other examples of the memory circuitry include latches, registers, and caches (e.g., SRAM).

The reconfigurable processors 695 are dynamically scalable to meet the performance objectives required by applications 668 (or user applications 668). The applications 668 access the reconfigurable processors 695 over one or more networks (e.g., Internet).

The reconfigurable processors 695 can have different compute scales and hierarchies according to different implementations of the technology disclosed. In one example, the reconfigurable processors 695 include a node (or a single machine) that has one or more reconfigurable processors, supported by required bus and memory circuitry. The node also includes a host processor (e.g., CPU) that exchanges data with the reconfigurable processors, for example, over a PCIe interface. The host processor includes a runtime processor 692 that manages resource allocation, memory mapping, and execution of the configuration files 682 for applications 668 requesting execution from the host processor. In another example, the reconfigurable processors 695 include a rack (or cluster) of nodes such that each node in the rack runs a respective plurality of reconfigurable processors, and includes a respective host processor configured with a respective runtime processor. The runtime processors are distributed across the nodes and communicate with each other so that they have unified access to the reconfigurable processors attached not just to their own node on which they run, but also to the reconfigurable processors attached to every other node in the data center.

The nodes in the rack are connected, for example, over Ethernet or InfiniBand (IB). In yet another example, the reconfigurable processors 695 include a pod that comprises a plurality of racks. In yet another example, the reconfigurable processors 695 is a superpod that comprises a plurality of pods. In yet another example, the reconfigurable processors 695 is a zone that comprises a plurality of superpods. In yet another example, the reconfigurable processors 695 is a data center that comprises a plurality of zones.

The applications 668 are executed on the reconfigurable processors 695 in a distributed fashion by programming the individual compute and memory components to asynchronously receive, process, and send data and control information. In the reconfigurable processors 695, computation can be executed as deep, nested dataflow pipelines that exploit nested parallelism and data locality very efficiently. These dataflow pipelines contain several stages of computation, where each stage reads data from one or more input buffers with an irregular memory access pattern, performs computations on the data while using one or more internal buffers to store and retrieve intermediate results, and produce outputs that are written to one or more output buffers. The structure of these pipelines depends on the control and dataflow graph representing the application. Pipelines can be arbitrarily nested and looped within each other.

The applications 668 comprise high-level programs. A high-level program may include source code written in programming languages like C, C++, Java, JavaScript, Python, and/or Spatial, for example, using deep learning frameworks such as PyTorch, TensorFlow, ONNX, Caffe, and/or Keras. The high-level program can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and/or Transformer-XL.

In one example, the high-level program can implement a large language model (LLM) with several processing layers that execute operations. The high-level program can execute irregular memory operations that involve accessing inputs and weights and performing matrix multiplications between the inputs and the weights. The high-level program can include nested loops with high iteration count and loop bodies that load and multiply input values from a preceding processing layer with weights from memory circuitry to produce an output for the succeeding processing layer. The high-level program can have loop-level parallelism of the outermost loop body, which can be exploited using coarse-grained pipelining. The high-level program can have instruction-level parallelism of the innermost loop body, which can be exploited using loop unrolling, SIMD vectorization, and pipelining.

The applications 668 are provided to a compiler in form of processing graphs (e.g., data flow graphs, control graphs) 670. The processing graphs 670 comprise nodes and edges. The nodes can represent compute operations and memory allocations. The edges can represent data flow and flow control. In some implementations, each loop in the high-level programs can be represented as a “controller” in the processing graphs 670. The processing graphs 670 support branches, loops, function calls, and other variations of control dependencies. In some implementations, after the processing graphs 670 are generated, additional analyses or optimizations focused on loop transformations can be performed, such as loop unrolling, loop pipelining, loop fission/fusion, and loop tiling.

A compiler 672 transforms the processing graphs 670 into a hardware-specific configuration, which is specified in configuration files 682 generated by the compiler 672. In one implementation, the compiler 672 partitions the processing graphs 670 into memory allocations and execution fragments, and these partitions are specified in the configuration files 682. Execution fragments represent operations on data. An execution fragment can comprise portions of a program representing an amount of work. An execution fragment can comprise computations encompassed by a set of loops, a set of graph nodes, or some other unit of work that requires synchronization. An execution fragment can comprise a fixed or variable amount of work, as needed by the program. Different ones of the execution fragments can contain different amounts of computation. Execution fragments can represent parallel patterns or portions of parallel patterns and are executable asynchronously.

Memory allocations represent the creation of logical memory spaces in on-chip and/or off-chip memory circuitry for data required to implement the processing graphs 670, and these memory allocations are specified in the configuration files 682. Memory allocations define the type and the number of hardware resources (functional units, storage, or connectivity components). Main memory (e.g., DRAM) is off-chip memory for which the memory allocations can be made. Scratchpad memory (e.g., SRAM) is on-chip memory for which the memory allocations can be made. Other memory types for which the memory allocations can be made for various access patterns and layouts include read-only lookup-tables (LUTs), fixed size queues (e.g., FIFOs), and register files.

The compiler 672 binds memory allocations to virtual memory units and binds execution fragments to virtual compute units, and these bindings are specified in the configuration files 682. In some implementations, the compiler 672 partitions execution fragments into memory fragments and compute fragments, and these partitions are specified in the configuration files 682.

A memory fragment comprises address calculations leading up to a memory access. A compute fragment comprises all other operations in the parent execution fragment. A single execution fragment can produce one or more memory fragments, depending on how many memory accesses exist in the original loop body. In cases where the same memory addressing logic is shared across multiple memory accesses, address calculation may be duplicated to create multiple memory fragments from the same execution fragment.

The memory fragments of the execution fragments are configured to index into data structures. At least one of the memory fragments indexes into a data structure in the logical memory spaces of one of the memory allocations.

The compiler 672 assigns the memory fragments to the virtual memory units and assigns the compute fragments to the virtual compute units, and these assignments are specified in the configuration files 682. Each memory fragment is mapped operation-wise to the virtual memory unit corresponding to the memory being accessed. Each operation is lowered to its corresponding configuration intermediate representation for that virtual memory unit. Each compute fragment is mapped operation-wise to a newly allocated virtual compute unit.

The compiler 672 allocates the virtual memory units to physical memory units of reconfigurable processors 695 (e.g., pattern memory units (PMUs) of one of the reconfigurable processors 695) and allocates the virtual compute units to physical compute units of reconfigurable processors 695 (e.g., pattern compute units (PCUs) of one of the reconfigurable processors 695), and these allocations are specified in the configuration files 682. The compiler 672 places the physical memory units and the physical compute units onto positions in an array of CGR units of the reconfigurable processors 695 and routes data and control networks between the placed positions, and these placements and routes are specified in the configuration files 682. In one implementation, this includes allocating physical resources such as counters and registers within each physical memory and compute unit, and these allocations are specified in the configuration files 682.

The compiler 672 may translate the applications 668 developed with commonly used open-source packages such as Keras and/or PyTorch into reconfigurable processor specifications. The compiler 672 generates the configuration files 682 with configuration data for the placed positions and the routed data and control networks.

In some implementations, different processing graphs 670 may be available for a same application 668. For example, a first processing graph 670 of an application 668 may represent a first configuration when implemented on the reconfigurable processor circuits 695, and a second processing graph 670 of the same application 668 may represent a second configuration when implanted on the reconfigurable processor circuits 695. As an example, the first and second configurations may have different performance characteristics such as throughput or latency. As another example, the first and second configurations may serve a different number of concurrent users.

In this example, the compiler 672 generates a first configuration file 682 for configuring a reconfigurable processor circuit 695 and associated memory circuitry 697 according to the first configuration and a second configuration file 682 for configuring the reconfigurable processor circuit 695 and the associated memory circuitry 697 according to the second configuration.

Consider the scenario in which the application includes a large language model (LLM) with a set of weights (checkpoint). In this scenario, the compiler 672 may generate two different configuration files 682 for configuring the reconfigurable processor circuits 695 and the reconfigurable memory 697 according to two different configurations based on the two different processing graphs 670. Each configuration file 682 may have a separate copy of the set of weights. However, the set of weights may be very large and to avoid long times of loading the set of weights into the reconfigurable processor memory 697, it is desirable that the two configurations share a same copy of the set of weights of which only one copy is then stored in the reconfigurable processor memory 697. Sharing the set of weights between the two different configuration files 682 requires that the compiler 672 generates the two configuration files 682 with sharing of the set of weights in mind, i.e., to support checkpoint sharing.

Illustratively, two different configuration files 682 can share a set of weights stored in associated memory circuitry if the set of weights is stored according to the same physical layout. For this purpose, the compiler 672 may generate a first configuration file 682 for configuring the reconfigurable processors 695 and associated memory circuitry 697 according to a first configuration and ensure that the set of weights as described in the first configuration file 682 has a shareable layout. The compiler 672 then generates a second configuration file 682 for configuring the reconfigurable processors 695 and the associated memory circuitry 697 according to a second configuration that is different than the first configuration. Thereby, the compiler 672 generates instructions in the second configuration file 682 for using the set of weights stored in the associated memory circuitry 697 according to the shareable layout.

The runtime processor 692 is coupled to the reconfigurable processors 695 via an interface. If desired, the interface may be a PCIe interface or any other interface that enables the runtime processor 692 to exchange data with the reconfigurable processors 695. The runtime processor 692 is also coupled to memory circuitry (e.g., to RP memory 697). If desired, when implementing an LLM on the reconfigurable processors 695, the runtime processor 692 can execute a runtime procedure for sharing checkpoints (i.e., the set of all weights in the LLM).

The runtime processor 692 receives the configuration files 682 from the compiler 672 and uses the configuration files 682 for resource allocation, memory mapping, and execution of the bit files for the applications 668 on the reconfigurable processors 695. For example, the runtime processor 692 receives a first configuration file 682 of a first configuration of an application 668 and a second configuration file 682 of a second configuration of the application 668, whereby the second configuration is different than the first configuration.

Illustratively, the second configuration may have different performance characteristics than the first configuration. As an example, the first configuration may have a first throughput and a first latency, while the second configuration has a second throughput and a second latency that are both different than the first throughput and the first latency. As another example, the first configuration may serve a first number of concurrent users while the second configuration serves a second number of concurrent users that is different than the first number of concurrent users.

Consider the scenario in which the runtime processor 692 configures the reconfigurable processors 695 and the reconfigurable processor (RP) memory 697 with first and second configurations for execution of an LLM. Consider further that the compiler 672 has generated first and second configuration files 682 such that the two configurations share a checkpoint. In this scenario, the runtime processor 692 loads the set of weights 685 for the first configuration (i.e., the first checkpoint) into RP memory 697. The set of weights 685 of the first checkpoint owns a set of regions in RP memory 697 as well as a schedule in the first configuration file 682. The schedule in the first configuration file includes the information in the first configuration file for loading the set of weights 685 from RP memory 697.

A second checkpoint for the second configuration is created from the first checkpoint for the first configuration. The second checkpoint is associated with the second configuration file and the set of weights 685 of the second checkpoint co-owns the set of regions in RP memory 697 as well as a schedule in the second configuration file 682. The schedule in the second configuration file includes the information in the second configuration file for loading the set of weights 685 from RP memory 697, whereby the schedule in the second configuration file is different than the schedule in the first configuration file.

The runtime processor 692 parses the configuration files 682. The configuration files 682 include configurations of the virtual data flow resources that are required to execute the user applications 668. The runtime processor 692 configures reconfigurable components in the reconfigurable processors 695 according to the configurations. In the example above, the runtime processor 692 configures first reconfigurable components in the reconfigurable processors 695 according to the first configuration. For example, after configuration, the first reconfigurable components are configured to access the memory circuitry (e.g., RP memory 697) to retrieve a shared set of weights 685 that is stored in the memory circuitry and implement a first set of operations that operates on the shared set of weights 685. The runtime processor 692 also configures second reconfigurable components in the reconfigurable processors 695 according to the second configuration. For example, after configuration, the second reconfigurable components are configured to access the memory circuitry (e.g., RP memory 697) to retrieve the shared set of weights 685 and implement a second set of operations that operates on the shared set of weights 685.

As an example, after configuration, the first reconfigurable components in the reconfigurable processors 695 receive the prompt “Hi! How are”, access the RP memory 697 to retrieve the shared set of weights 685, implement a first set of operations that operates on the shared set of weights and on the prompt to generate the string “you”. The second reconfigurable components in the reconfigurable processors 695 receive the prompt “Thank you”, access the RP memory 697 to retrieve the shared set of weights 685, implement a second set of operations that operates on the shared set of weights 685 and on the prompt to generate the string “very much”.

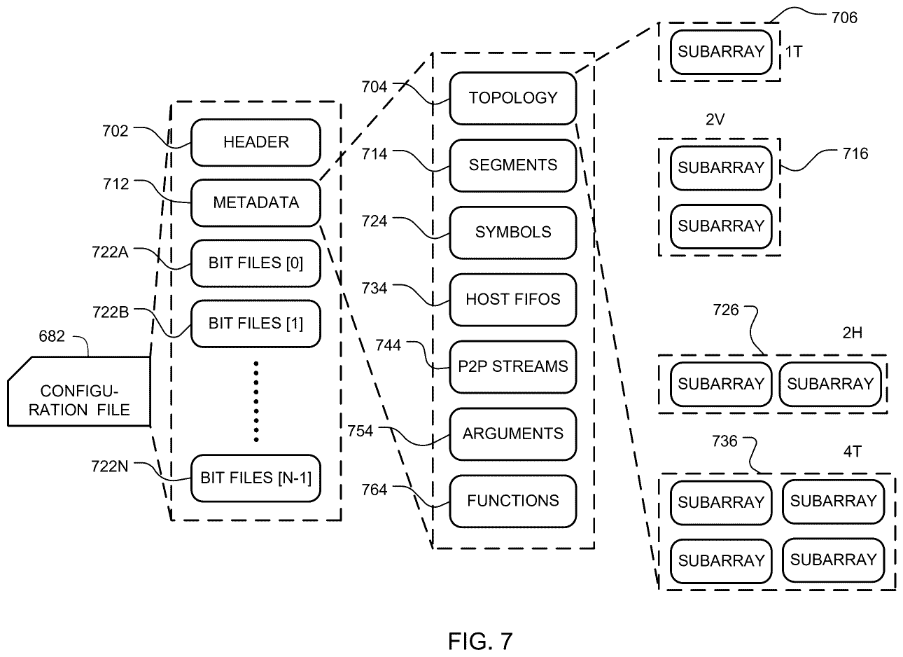

The configuration files 682 can include bit files and metadata 687. As further illustrated with respect to FIG. 7, the first configuration file 682 may include a first bit file 722A and metadata 712, which may include a first argument table 754. The second configuration file 682 may include a second bit file 722A and metadata 712, which may include a second argument table 754. The runtime processor 692 may store the first and second configuration files 682 in memory circuitry (e.g., RP memory 697). For configuring first reconfigurable components in the reconfigurable processor circuits 695 according to the first configuration, the reconfigurable processor circuits 695 may load the first bit file and the first argument table from the memory circuitry, and override first predetermined numerical constants in the first bit file with corresponding values from the first argument table. Illustratively, the first predetermined numerical constants in the first bit file comprise at least a first virtual address associated with a physical address in the memory circuitry such as RP memory 697.

For configuring second reconfigurable components in the reconfigurable processor circuits according to the second configuration, the reconfigurable processor circuits 695 may load the second bit file and the second argument table from the memory circuitry, and override second predetermined numerical constants in the second bit file with corresponding values from the second argument table. Illustratively, the second predetermined numerical constants in the second bit file comprise at least a second virtual address associated with the physical address in the memory circuitry such as RP memory 697, whereby the memory circuitry 697 stores a weight of the shared set of weights 685 at the physical address.

In some scenarios, the first reconfigurable components comprise first programmable compute units (e.g., PCUs 520 of FIG. 5), first programmable memory units (e.g., PMUs 510 of FIG. 5), and first programmable interconnections (e.g., switch units 403 and interconnects 421, 422 of FIG. 4) between the first programmable compute units and the first programmable memory units, wherein the second reconfigurable components comprise second programmable compute units, second programmable memory units, and second programmable interconnections between the second programmable compute units and the second programmable memory units.

In these scenarios, the runtime processor 692 may be configured to program first programmable compute units, first programmable memory units, and first programmable interconnections using the first bit file and the first argument table. If desired, the runtime processor 692 may be configured to program second programmable compute units, second programmable memory units, and second programmable interconnections using the second bit file and the second argument table.

Illustratively, the runtime processor 692 may be configured to identify a first set of symbols (e.g., symbols 724 of FIG. 7) having a first number of symbols in first metadata (e.g., metadata 712 of FIG. 7) of the first configuration file 682, whereby each symbol in the first set of symbols is associated with a different weight of the shared set of weights 685. By way of example, the runtime processor 692 may be configured to identify a second set of symbols having a second number of symbols in second metadata of the second configuration file 682, wherein each symbol in the second set of symbols is associated with another different weight of the shared set of weights 685.

The second reconfigurable components can be the same as the first reconfigurable components or different from the first reconfigurable components. If desired, a subset of the second reconfigurable components can be shared with the first reconfigurable components, or a subset of the first reconfigurable components can be shared with the second reconfigurable components.

The shared portion of the first and second reconfigurable components implements either one of the first or second configuration at a given point in time. In other words, at a time T1, the shared portion of the first and second reconfigurable components can implement the first configuration but not the second configuration, and at a different time T2, the shared portion of the first and second reconfigurable components can implement the second configuration but not the first configuration.

In some implementations, the runtime processor 692 implements the first configuration in virtual machine VM1 that is allocated first reconfigurable components and implements the second configuration in virtual machine VM2 that is allocated second reconfigurable components. Virtual machine VM1 includes a first set of CGR units, which can include some or all CGR units of a single reconfigurable processor circuit or of multiple reconfigurable processor circuits, along with associated bus and memory circuitry (e.g., PCIe channels, DMA channels, DDR channels, DRAM memory, HBM). Virtual machine VM2 includes a second set of CGR units, which can include some or all CGR units of a single reconfigurable processor circuit or of multiple reconfigurable processor circuits, along with associated bus and memory circuitry (e.g., PCIe channels, DMA channels, DDR channels, DRAM memory, HBM).

The runtime processor 692 respects the topology information (e.g., topology information 704 of FIG. 7) in the configuration files 682 when allocating CGR units to the virtual data flow resources requested in the configuration files 682. For example, consider the scenario in which the reconfigurable processor has a non-uniform communication bandwidth in East/West directions versus North/South directions. In this scenario, a virtual tile geometry that requires, for example, two tiles arranged horizontally, may suffer in performance if mapped to a physical tile geometry in which two tiles are arranged vertically. In some implementations, the topology information may specify rectilinear tile geometries.

The runtime processor 692 may then start execution of the user application 668 on the reconfigurable components of the reconfigurable processors 695.

FIG. 7 illustrates an example configuration file 682. As described above, the configuration file 682 include bit files 722a, 722b, . . . 722n that implement the processing graphs 670 of the user applications 668 using the reconfigurable components in the reconfigurable processor circuits 695 of FIG. 6.

A program executable contains a bit-stream representing the initial configuration, or starting state, of each of the physical reconfigurable components that execute the program. This bit-stream is referred to as a bit file. The configuration file 682 includes header 702 that indicates destinations on the reconfigurable processor circuits for configuration data in the bit files. In some implementations, a plurality of bit files is generated for a single application.

The configuration file 682 can include a sequence of bit file-argument table pairs. The argument tables are configured as appropriate, and when runtime configures thee reconfigurable components in the reconfigurable processor circuits, runtime executes each bit file in the appropriate sequence.

Each operation may have a unique argument table. Bit files may be shared across multiple operations, if desired.

Illustratively, the argument table and the bit files may be stored in memory circuitry. As an example, a host processor (e.g., host processor 180 of FIG. 1) may store the argument table and the bit files in HBM. As another example, the host processor may store the argument tables and the bit files in DDR memory.

In some implementations, upon a program load, the reconfigurable processor circuit may override the arguments in the bit files with values from the argument table on the fly when configuring the reconfigurable components. In other words, the reconfigurable processor circuit loads both the bit file and the argument table, and the loaded programming includes the configuration from the bit file modified in accordance with the argument table. Note that as part of this loading process, neither the argument table nor the bit file are modified in the memory circuitry (e.g., in HBM). In other implementations, the runtime processor may modify the bit file in accordance with the argument table and configure the reconfigurable components in the reconfigurable processor circuits with the modified bit file.

Illustratively, the configuration file 682 includes metadata 712 that accompanies the bit files and specifies configurations of virtual data flow resources required to execute the applications (e.g., applications 668 of FIG. 6). In one example, the configuration file 682 can specify that a particular application needs an entire reconfigurable processor for execution, and as a result the metadata 712 identifies virtual data flow resources equaling at least the entire reconfigurable processor for loading and executing the bit files for the particular application. In another example, the configuration file 682 can specify that a particular application needs one or more portions of a reconfigurable processor for execution, and as a result the metadata 712 identifies virtual data flow resources equaling at least the one or more portions of the reconfigurable processor for loading and executing the bit files for the particular application. In yet another example, the configuration file 682 can specify that a particular application needs two or more reconfigurable processors for execution, and as a result the metadata 712 identifies virtual data flow resources equaling at least the two or more reconfigurable processors for loading and executing the bit files for the particular application. In yet another example, the configuration file 682 can specify that a particular application needs an entire first reconfigurable processor and one or more portions of a second reconfigurable processor for execution, and as a result the metadata 712 identifies virtual data flow resources equaling at least the first reconfigurable processor and the one or more portions of the second reconfigurable processor for loading and executing the bit files for the particular application.

One skilled in the art would appreciate that the configuration file 682 can similarly specify reconfigurable processors or portions thereof spanning across racks, pods, superpods, and zones in a data center, and as a result the metadata 712 identifies virtual data flow resources spanning across the racks, pods, superpods, and zones in the data center for loading and executing the bit files for the particular application.

As part of the metadata 712, the configuration file 682 includes topology information 704 that specifies orientation or shapes of portions of a reconfigurable processor required to load and execute the bit files for a particular application. A reconfigurable processor circuit may include reconfigurable components that are arranged in one or more arrays of CGR units (e.g., CGR processor 110 of FIG. 1 may include arrays of CGR units 120) in a programmable interconnect fabric (e.g., array-level network ALN of FIG. 1). If desired, an array of CGR units may include compute units and/or memory units. The arrays of CGR units in the reconfigurable processor circuits (e.g., reconfigurable processors 695 of FIG. 6) may be partitionable into two or more subsets of arrays of CGR units. A subset is a set (or grid) of arrays of CGR units and covers at least a portion of the arrays of CGR units in the reconfigurable processor circuits. Illustratively, a reconfigurable processor circuit may include a plurality of tiles, whereby a tile is a portion of the arrays of CGR units with a certain number of CGR units.

In one implementation, a reconfigurable processor circuit comprises a plurality of tiles of configurable units, for example, four tiles that form an array of CGR units in the reconfigurable processor circuit. The topology information 704 specifies an orientation of tiles in the plurality of tiles required to load and execute the bit files for a particular application.

For example, when the particular application is allocated two tiles of the reconfigurable processor circuit, the topology information 704 specifies whether the two tiles are arranged in a vertical orientation (2V) 716 or a horizontal orientation (2H) 726. The topology information 704 can also allocate a single tile (1T) 706 of the reconfigurable processor circuit to the particular application. The topology information 704 can also allocate four tiles (4T) 736 of the reconfigurable processor circuit to the particular application. In other implementations, other geometries may be specified, such as a group of three tiles.

The configuration file 682 also specifies virtual flow resources like PCIe channels, DMA channels, and DDR channels required to load and execute the bit files for a particular application. The configuration file 682 also specifies virtual flow resources like main memory (e.g., off-chip/external DRAM), local secondary storage (e.g., local disks (e.g., HDD, SSD)), remote secondary storage (e.g., distributed file systems, web servers), latches, registers, and caches (e.g., SRAM) required to load and execute the bit files for a particular application.

The configuration file 682 also specifies virtual memory segments 714 for the requested virtual flow resources, including virtual address spaces of the virtual memory segments and sizes of the virtual address spaces. The configuration file 682 also specifies symbols 724 (e.g., tensors, streams, data partitions) required to load and execute the bit files for a particular application and/or to load weights from a data partition during execution of an application. The configuration file 682 also specifies HOST FIFOs 734 accessed by the bit files for a particular application during execution. The configuration file 682 also specifies peer-to-peer (P2P) streams 744 (e.g., data flow exchanges and control token exchanges between sources and sinks) exchanged between configurable units on which the bit files for a particular application are loaded and executed. The configuration file 682 also specifies arguments 754 that modify execution logic of a particular application by supplying additional parameters or new parameter values to the bit files for the particular application. The configuration file 682 also specifies functions 764 (e.g., data access functions like transpose, alignment, padding) to be performed by the configurable units on which the bit files for a particular application are loaded and executed.

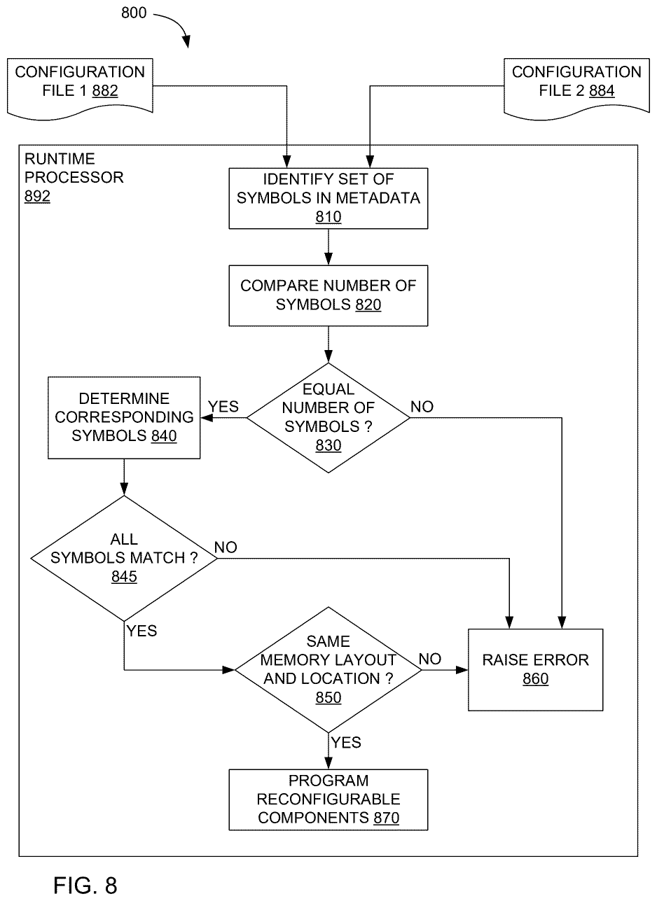

FIG. 8 illustrates an example flowchart 800 of illustrative operations that a runtime processor 892 performs for implementing checkpoint sharing when programming reconfigurable components of reconfigurable processors (e.g., reconfigurable processors 695 of FIG. 6).

As shown in FIG. 8, runtime processor 892 may receive configuration file 1 882 and configuration file 2 884. For example, configuration file 1 882 is adapted for configuring reconfigurable components of the reconfigurable processors according to a first configuration of an application (e.g., application 668 of FIG. 6), and configuration file 2 884 is adapted for configuring reconfigurable components of the reconfigurable processors according to a second configuration of the application which is different than the first configuration. In some implementations, the reconfigurable components can be arranged in arrays of coarse-grained reconfigurable (CGR) units.

Illustratively, the first configuration file 882 includes a first bit file and a first argument table stored in memory circuitry, and the second configuration file includes a second bit file and a second argument table stored in the memory circuitry.

During operation 810, the runtime processor 892 may identify set of symbols in metadata. For example, the runtime processor 892 may identify a first set of symbols (e.g., symbols 724 of FIG. 7) having a first number of symbols in first metadata (e.g., metadata 712 of FIG. 7) of the first configuration file 882, whereby each symbol in the first set of symbols is associated with a different weight of the shared set of weights (e.g., set of weights 685 of FIG. 6), and the runtime processor 892 may identify a second set of symbols (e.g., symbols 724 of FIG. 7) having a second number of symbols in second metadata (e.g., metadata 712 of FIG. 7) of the second configuration file 884, whereby each symbol in the second set of symbols is associated with another different weight of the shared set of weights (e.g., set of weights 685 of FIG. 6).

During operation 820, the runtime processor 892 may compare the number of symbols in the first set of symbols with the number of symbols in the second set of symbols.

During operation 830, the runtime processor 892 may verify that the second number of symbols is equal to the first number of symbols. In response to detecting that the second number of symbols is different than the first number of symbols, the runtime processor 892 may raise an error during operation 860.

In response to detecting that the second number of symbols is equal to the first number of symbols, the runtime processor 892 may determine corresponding symbols during operation 840. For example, the runtime processor 892 may for each symbol in the second set of symbols associate the symbol with a corresponding symbol in the first set of symbols.

During operation 845, the runtime processor 892 may verify whether all symbols match (i.e., whether there is a corresponding symbol in the first set of symbols for each symbol in the second set of symbols and there is a corresponding symbol in the second set of symbols for each symbol in the first set of symbols). In response to detecting that not all symbols in the first set of symbols have a corresponding symbol in the second set of symbols, the runtime processor 892 may raise an error during operation 860. If desired, the runtime processor 892 may raise an error during operation 860 in response to detecting that not all symbols in the second set of symbols have a corresponding symbol in the first set of symbols. In some implementations, the runtime processor 892 may raise an error during operation 860 if one of the symbols in the second set of symbols fails to be associated with a corresponding symbol in the first set of symbols or if one of the symbols in the first set of symbols fails to be associated with a corresponding symbol in the second set of symbols.

In response to detecting that all symbols in the first set of symbols have a corresponding symbol in the second set of symbols and that all symbols in the second set of symbols have a corresponding symbol in the first set of symbols, the runtime processor 892 may verify that each symbol in the second set of symbols and the corresponding symbol in the first set of symbols is associated with a same location and a same layout in the memory circuitry during operation 850. As an example, symbols may be associated with a same location and a same layout in the memory circuitry if the symbols are stored at a same physical address in the same type of memory resource (e.g., HBM or DDR memory). As another example, symbols may be associated with a same location and a same layout in the memory circuitry if the symbols are stored in a same pool of memory resources. Consider the scenario in which each reconfigurable processor of reconfigurable processors 695 of FIG. 6 has its own set of 17 memory pools: a DDR memory pool and 16 distinct HBM pools. In this scenario, a symbol's location can be freely changed within the pool of the set of 17 memory pools, but a symbol may not be moved into different memory pools. Illustratively, a system with 16 reconfigurable processors 695 has 16*17=272 different memory pools.

In response to detecting that one of the symbols in the second set of symbols fails to be associated with a same location and a same layout in the memory circuitry as the corresponding symbol in the first set of symbols, the runtime processor 892 may raise an error during operation 860.

In response to detecting that all symbols in the second set of symbols are associated with a same location and a same layout in the memory circuitry as the corresponding symbol in the first set of symbols, the runtime processor 892 may program the reconfigurable components of the reconfigurable processor circuits during operation 870.

Illustratively, the reconfigurable processors 695 of FIG. 6 may load the bit files, symbols, and argument tables from memory circuitry and use the bit files, symbols, and argument tables to program programmable compute units, programmable memory units, and programmable interconnections in the reconfigurable processors 695. As an example, consider the scenario in which the memory circuitry stores a weight of the shared set of weights at a predetermined physical address. In this scenario, for configuring first reconfigurable components in the reconfigurable processors 695 according to a first configuration, the reconfigurable processors may load the first bit file and the first argument table from the memory circuitry, and override first predetermined numerical constants in the first bit file with corresponding values from the first argument table, whereby the first predetermined numerical constants in the first bit file comprise at least a first virtual address associated with the predetermined physical address in the memory circuitry, and for configuring second reconfigurable components in the reconfigurable processor circuits according to a second configuration, the reconfigurable processor circuits may load the second bit file and the second argument table from the memory circuitry, and override second predetermined numerical constants in the second bit file with corresponding values from the second argument table, whereby the second predetermined numerical constants in the second bit file comprise at least a second virtual address associated with the predetermined physical address in the memory circuitry.

By way of example, the first and second reconfigurable components in the reconfigurable processors can be arranged in arrays of coarse-grained reconfigurable (CGR) units. In some implementations, the first and second reconfigurable components are configured to access the memory circuitry via a double data rate (DDR) interface or a high-bandwidth memory (HBM) interface.

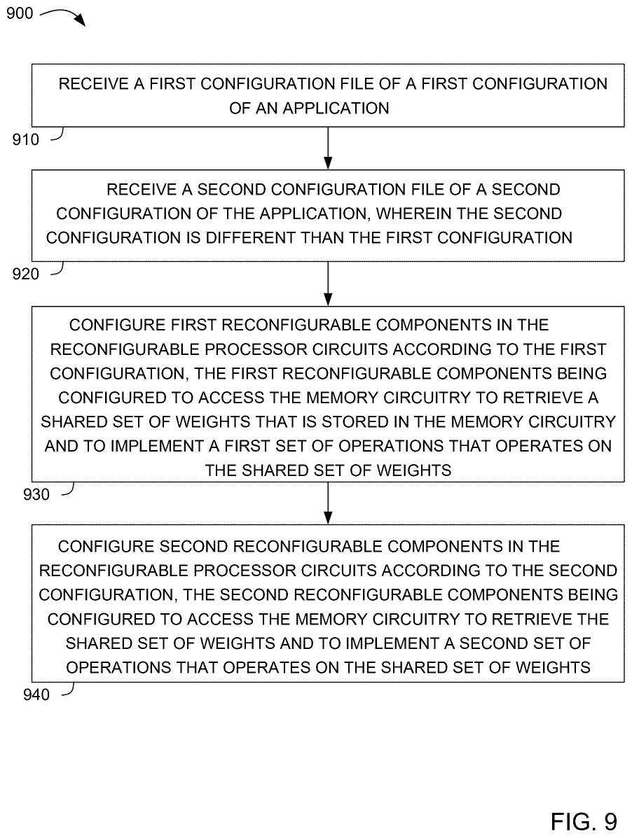

FIG. 9 illustrates an example method 900 of operating a data processing system including a runtime processor that is coupled to reconfigurable processor circuits and memory circuitry such as data processing system 660 of FIG. 6 with runtime processor 692 that is coupled to reconfigurable processors 695 and reconfigurable processor memory 697.

During operation 910, the runtime processor receives a first configuration file of a first configuration of an application. For example, runtime processor 692 of data processing system 660 of FIG. 6 may receive a first configuration file of configuration files 682 of a first configuration of application 668.

During operation 920, the runtime processor receives a second configuration file of a second configuration of the application, wherein the second configuration is different than the first configuration. For example, runtime processor 692 of FIG. 6 may receive a second configuration file of configuration files 682 of a second configuration of application 668, whereby the second configuration is different than the first configuration.

During operation 930, the data processing system configures first reconfigurable components in the reconfigurable processor circuits according to the first configuration, whereby the first reconfigurable components are configured to: access the memory circuitry to retrieve a shared set of weights that is stored in the memory circuitry; and implement a first set of operations that operates on the shared set of weights. For example, the data processing system 660 of FIG. 6 may configure first reconfigurable components in the reconfigurable processors 695 according to the first configuration, whereby the first reconfigurable components are configured to: access the reconfigurable processor memory 697 to retrieve a shared set of weights that is stored in the reconfigurable processor memory 697, and implement a first set of operations that operates on the shared set of weights.

During operation 940, the data processing system configures second reconfigurable components in the reconfigurable processor circuits according to the second configuration, whereby the second reconfigurable components are configured to: access the memory circuitry to retrieve the shared set of weights, and implement a second set of operations that operates on the shared set of weights. For example, the data processing system 660 of FIG. 6 may configure second reconfigurable components in the reconfigurable processors 695 according to the second configuration, whereby the second reconfigurable components are configured to: access the reconfigurable processor memory 697 to retrieve the shared set of weights, and implement a second set of operations that operates on the shared set of weights.

In some scenarios, the first configuration file includes a first bit file and a first argument table, and the second configuration file includes a second bit file and a second argument table. In these scenarios, the reconfigurable processor circuits of the data processing system may load the first bit file and the first argument table from the memory circuitry and override first predetermined numerical constants in the first bit file with corresponding values from the first argument table. Illustratively, the first predetermined numerical constants in the first bit file include at least a first virtual address that is associated with a physical address in the memory circuitry. For example, the configuration file 682 of FIG. 7 includes bit file 722A and arguments 754 in metadata 712. The bit file and the arguments may be stored in reconfigurable processor memory 697 of FIG. 6, and the reconfigurable processors 695 of data processing system 660 may load the bit file 722A and arguments 754 from RP memory 697 and override predetermined numerical constants in the bit file 722A with corresponding values from the arguments 754. If desired, the reconfigurable processor circuits may load the second bit file and the second argument table from the memory circuitry and override second predetermined numerical constants in the second bit file with corresponding values from the second argument table, whereby the second predetermined numerical constants in the second bit file include at least a second virtual address associated with the physical address in the memory circuitry, and whereby the memory circuitry stores a weight of the shared set of weights at the physical address. For example, the bit file and the arguments of this second configuration file may be stored in RP memory 697 of FIG. 6, and the reconfigurable processors 695 of data processing system 660 may load the bit file and arguments from RP memory 697 an override predetermined numerical constants in the bit file with corresponding values from the arguments, whereby the second predetermined numerical constants in the second bit file include at least a second virtual address associated with the physical address in the reconfigurable processor memory 697, and whereby the reconfigurable processor memory 697 stores a weight of the shared set of weights at the physical address.

Consider the scenario in which the first reconfigurable components include first programmable compute units (e.g., PCU 520 of FIG. 5), first programmable memory units (e.g., PMU 510 of FIG. 5), and first programmable interconnections (e.g., interconnections 422 and switches 403 of FIG. 4) between the first programmable compute units and the first programmable memory units. Consider further that the second reconfigurable components include second programmable compute units (e.g., PCU 520 of FIG. 5), second programmable memory units (e.g., PMU 510 of FIG. 5), and second programmable interconnections (e.g., interconnections 422 and switches 403 of FIG. 4) between the second programmable compute units and the second programmable memory units. In this scenario, the data processing system 660 of FIG. 6 may program first programmable compute units, first programmable memory units, and first programmable interconnections in the reconfigurable processors 695 using the first bit file (e.g., bit file 722A of FIG. 7) and the first argument table (e.g., arguments 754 of FIG. 7), and program second programmable compute units, second programmable memory units, and second programmable interconnections in the reconfigurable processors 695 using the second bit file and the second argument table.

Illustratively, the data processing system may identify a first set of symbols such as symbols 724 of FIG. 7 having a first number of symbols in first metadata such as metadata 712 of FIG. 7 of the first configuration file 882 of FIG. 8, whereby each symbol in the first set of symbols is associated with a different weight of the shared set of weights, and identify a second set of symbols (e.g., symbols 724 of FIG. 7) having a second number of symbols in second metadata (e.g., metadata 712 of FIG. 7) of the second configuration file (e.g., configuration file 884 of FIG. 8), whereby each symbol in the second set of symbols is associated with another different weight of the shared set of weights.

By way of example, the data processing system may verify that the second number of symbols is equal to the first number of symbols, and for each symbol in the second set of symbols, associate the symbol with a corresponding symbol in the first set of symbols.

If desired, the data processing system may raise an error in response to detecting that the second number of symbols is different than the first number of symbols or that one of the symbols in the second set of symbols fails to be associated with a corresponding symbol in the first set of symbols.

Illustratively, the data processing system may verify that each symbol in the second set of symbols and the corresponding symbol in the first set of symbols is associated with a same location and a same layout in the memory circuitry.

If desired, the data processing system may raise an error in response to detecting that one of the symbols in the second set of symbols fails to be associated with a same location and a same layout in the memory circuitry as the corresponding symbol in the first set of symbols.

### Particular Implementations

Described implementations of the subject matter can include one or more features, alone or in combination.

As an example, a data processing system comprises reconfigurable processor circuits; memory circuitry that is coupled to the reconfigurable processor circuits; and a runtime processor that is coupled to the reconfigurable processor circuits and the memory circuitry, the runtime processor being configured to: receive a first configuration file of a first configuration of an application; receive a second configuration file of a second configuration of the application, wherein the second configuration is different than the first configuration; configure first reconfigurable components in the reconfigurable processor circuits according to the first configuration, the first reconfigurable components being configured to: access the memory circuitry to retrieve a shared set of weights that is stored in the memory circuitry; and implement a first set of operations that operates on the shared set of weights; and configure second reconfigurable components in the reconfigurable processor circuits according to the second configuration, the second reconfigurable components being configured to: access the memory circuitry to retrieve the shared set of weights, and implement a second set of operations that operates on the shared set of weights.

The foregoing example and other described implementations can each, optionally, include one or more of the following features:
(2) the first and second reconfigurable components are arranged in arrays of coarse-grained reconfigurable (CGR) units.
(3) the first and second reconfigurable components are configured to access the memory circuitry via a double data rate (DDR) interface or a high-bandwidth memory (HBM) interface.
(4) the first configuration file comprises a first bit file and a first argument table stored in the memory circuitry, wherein the second configuration file comprises a second bit file and a second argument table stored in the memory circuitry, wherein for configuring first reconfigurable components in the reconfigurable processor circuits according to the first configuration, the reconfigurable processor circuits load the first bit file and the first argument table from the memory circuitry, and override first predetermined numerical constants in the first bit file with corresponding values from the first argument table, wherein the first predetermined numerical constants in the first bit file comprise at least a first virtual address associated with a physical address in the memory circuitry, and wherein for configuring second reconfigurable components in the reconfigurable processor circuits according to the second configuration, the reconfigurable processor circuits load the second bit file and the second argument table from the memory circuitry, and override second predetermined numerical constants in the second bit file with corresponding values from the second argument table, wherein the second predetermined numerical constants in the second bit file comprise at least a second virtual address associated with the physical address in the memory circuitry, and wherein the memory circuitry stores a weight of the shared set of weights at the physical address.
(5) the first reconfigurable components comprise first programmable compute units, first programmable memory units, and first programmable interconnections between the first programmable compute units and the first programmable memory units, wherein the second reconfigurable components comprise second programmable compute units, second programmable memory units, and second programmable interconnections between the second programmable compute units and the second programmable memory units, and wherein the runtime processor is further configured to: program first programmable compute units, first programmable memory units, and first programmable interconnections using the first bit file and the first argument table; and program second programmable compute units, second programmable memory units, and second programmable interconnections using the second bit file and the second argument table.
(6) the runtime processor is further configured to: identify a first set of symbols having a first number of symbols in first metadata of the first configuration file, wherein each symbol in the first set of symbols is associated with a different weight of the shared set of weights; and identify a second set of symbols having a second number of symbols in second metadata of the second configuration file, wherein each symbol in the second set of symbols is associated with another different weight of the shared set of weights.
(7) the runtime processor is further configured to: verify that the second number of symbols is equal to the first number of symbols; and for each symbol in the second set of symbols, associate the symbol with a corresponding symbol in the first set of symbols.
(8) the runtime processor is further configured to: raise an error in response to detecting that the second number of symbols is different than the first number of symbols or that one of the symbols in the second set of symbols fails to be associated with a corresponding symbol in the first set of symbols.
(9) the runtime processor is further configured to: verify that each symbol in the second set of symbols and the corresponding symbol in the first set of symbols is associated with a same location and a same layout in the memory circuitry.
(10) the runtime processor is further configured to: raise an error in response to detecting that one of the symbols in the second set of symbols fails to be associated with a same location and a same layout in the memory circuitry as the corresponding symbol in the first set of symbols.

As another example, a method of operating a data processing system comprising a runtime processor that is coupled to reconfigurable processor circuits and memory circuitry, comprises: with the runtime processor, receiving a first configuration file of a first configuration of an application; with the runtime processor, receiving a second configuration file of a second configuration of the application, wherein the second configuration is different than the first configuration; configuring first reconfigurable components in the reconfigurable processor circuits according to the first configuration, the first reconfigurable components being configured to: access the memory circuitry to retrieve a shared set of weights that is stored in the memory circuitry; and implement a first set of operations that operates on the shared set of weights; and configuring second reconfigurable components in the reconfigurable processor circuits according to the second configuration, the second reconfigurable components being configured to: access the memory circuitry to retrieve the shared set of weights, and implement a second set of operations that operates on the shared set of weights.

The foregoing example and other described implementations can each, optionally, include one or more of the following features:
(1) the first configuration file comprises a first bit file and a first argument table, wherein the second configuration file comprises a second bit file and a second argument table, the method further comprising: with the reconfigurable processor circuits, loading the first bit file and the first argument table from the memory circuitry; overriding first predetermined numerical constants in the first bit file with corresponding values from the first argument table, wherein the first predetermined numerical constants in the first bit file comprise at least a first virtual address associated with a physical address in the memory circuitry; with the reconfigurable processor circuits, loading the second bit file and the second argument table from the memory circuitry; and overriding second predetermined numerical constants in the second bit file with corresponding values from the second argument table, wherein the second predetermined numerical constants in the second bit file comprise at least a second virtual address associated with the physical address in the memory circuitry, and wherein the memory circuitry stores a weight of the shared set of weights at the physical address.
(2) the first reconfigurable components comprise first programmable compute units, first programmable memory units, and first programmable interconnections between the first programmable compute units and the first programmable memory units, wherein the second reconfigurable components comprise second programmable compute units, second programmable memory units, and second programmable interconnections between the second programmable compute units and the second programmable memory units, the method further comprising: programming first programmable compute units, first programmable memory units, and first programmable interconnections using the first bit file and the first argument table; and programming second programmable compute units, second programmable memory units, and second programmable interconnections using the second bit file and the second argument table.
(3) identifying a first set of symbols having a first number of symbols in first metadata of the first configuration file, wherein each symbol in the first set of symbols is associated with a different weight of the shared set of weights; and identifying a second set of symbols having a second number of symbols in second metadata of the second configuration file, wherein each symbol in the second set of symbols is associated with another different weight of the shared set of weights.
(4) verifying that the second number of symbols is equal to the first number of symbols; and for each symbol in the second set of symbols, associating the symbol with a corresponding symbol in the first set of symbols.
(5) raising an error in response to detecting that the second number of symbols is different than the first number of symbols or that one of the symbols in the second set of symbols fails to be associated with a corresponding symbol in the first set of symbols.
(6) verifying that each symbol in the second set of symbols and the corresponding symbol in the first set of symbols is associated with a same location and a same layout in the memory circuitry.
(7) raising an error in response to detecting that one of the symbols in the second set of symbols fails to be associated with a same location and a same layout in the memory circuitry as the corresponding symbol in the first set of symbols.

As another example, a non-transitory computer-readable storage medium includes instructions that, when executed by a processing unit, cause the processing unit to operate a runtime processor, the instructions comprising: receiving a first configuration file of a first configuration of an application; receiving a second configuration file of a second configuration of the application, wherein the second configuration is different than the first configuration; configuring first reconfigurable components in reconfigurable processor circuits according to the first configuration, the first reconfigurable components being configured to: access memory circuitry that is associated with the reconfigurable processor circuits to retrieve a shared set of weights that is stored in the memory circuitry; and implement a first set of operations that operates on the shared set of weights; and configuring second reconfigurable components in the reconfigurable processor circuits according to the second configuration, the second reconfigurable components being configured to: access the memory circuitry to retrieve the shared set of weights, and implement a second set of operations that operates on the shared set of weights.

The foregoing example and other described implementations can each, optionally, include one or more of the following features:
(1) the first configuration file comprises a first bit file and a first argument table, wherein the second configuration file comprises a second bit file and a second argument table, and wherein the instructions further comprise: overriding first predetermined numerical constants in the first bit file with corresponding values from the first argument table to generate an updated first bit file, wherein the first predetermined numerical constants comprise at least a first virtual address associated with a physical address in the memory circuitry, and wherein the memory circuitry stores a weight of the shared set of weights at the physical address; overriding second predetermined numerical constants in the second bit file with corresponding values from the second argument table to generate an updated second bit file, wherein the second predetermined numerical constants comprise at least a second virtual address associated with the physical address in the memory circuitry; programming the first reconfigurable components with the updated first bit file; and programming the second reconfigurable components with the updated second bit file.

### Considerations

We describe various implementations of implementing checkpoint sharing in a reconfigurable processor circuit such that different configurations of an LLM can use a same set of weights stored in memory circuitry when being executed on the reconfigurable processor circuit.

The technology disclosed can be practiced as an apparatus, method, composition of matter, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections-these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

As an example, the runtime processor 692 of FIG. 6 is shown to configure the reconfigurable components of reconfigurable processors 695 with bit files and metadata 687 directly. However, runtime processor 692 may store bit files and metadata 687 in memory circuitry, and the reconfigurable processors may retrieve the bit files and metadata 687 from the memory circuitry for configuring the reconfigurable components in reconfigurable processors 695 instead.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to specific implementations thereof, these specific implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, a coarse-grained reconfigurable architecture (CGRA), or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable technology for manufacturing electronic devices can be used to implement the circuits of specific implementations, including CMOS, FinFET, GAAFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operating in parallel.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A data processing system, comprising:
reconfigurable processor circuits;
memory circuitry that is coupled to the reconfigurable processor circuits; and
a runtime processor that is coupled to the reconfigurable processor circuits and the memory circuitry, the runtime processor being configured to:
receive a first configuration file of a first configuration of an application;
receive a second configuration file of a second configuration of the application, wherein the second configuration is different than the first configuration;
configure first reconfigurable components in the reconfigurable processor circuits according to the first configuration, the first reconfigurable components being configured to:
access the memory circuitry to retrieve a shared set of weights that is stored in the memory circuitry; and
implement a first set of operations that operates on the shared set of weights; and
configure second reconfigurable components in the reconfigurable processor circuits according to the second configuration, the second reconfigurable components being configured to:
access the memory circuitry to retrieve the shared set of weights, and
implement a second set of operations that operates on the shared set of weights.

2. The data processing system of claim 1, wherein the first and second reconfigurable components are arranged in arrays of coarse-grained reconfigurable (CGR) units.

3. The data processing system of claim 1, wherein the first and second reconfigurable components are configured to access the memory circuitry via a double data rate (DDR) interface or a high-bandwidth memory (HBM) interface.

4. The data processing system of claim 1, wherein the first configuration file comprises a first bit file and a first argument table stored in the memory circuitry, wherein the second configuration file comprises a second bit file and a second argument table stored in the memory circuitry, wherein for configuring first reconfigurable components in the reconfigurable processor circuits according to the first configuration, the reconfigurable processor circuits load the first bit file and the first argument table from the memory circuitry, and override first predetermined numerical constants in the first bit file with corresponding values from the first argument table, wherein the first predetermined numerical constants in the first bit file comprise at least a first virtual address associated with a physical address in the memory circuitry, and wherein for configuring second reconfigurable components in the reconfigurable processor circuits according to the second configuration, the reconfigurable processor circuits load the second bit file and the second argument table from the memory circuitry, and override second predetermined numerical constants in the second bit file with corresponding values from the second argument table, wherein the second predetermined numerical constants in the second bit file comprise at least a second virtual address associated with the physical address in the memory circuitry, and wherein the memory circuitry stores a weight of the shared set of weights at the physical address.

5. The data processing system of claim 4, wherein the first reconfigurable components comprise first programmable compute units, first programmable memory units, and first programmable interconnections between the first programmable compute units and the first programmable memory units, wherein the second reconfigurable components comprise second programmable compute units, second programmable memory units, and second programmable interconnections between the second programmable compute units and the second programmable memory units, and wherein the runtime processor is further configured to:
program first programmable compute units, first programmable memory units, and first programmable interconnections using the first bit file and the first argument table; and
program second programmable compute units, second programmable memory units, and second programmable interconnections using the second bit file and the second argument table.

6. The data processing system of claim 4, wherein the runtime processor is further configured to:
identify a first set of symbols having a first number of symbols in first metadata of the first configuration file, wherein each symbol in the first set of symbols is associated with a different weight of the shared set of weights; and
identify a second set of symbols having a second number of symbols in second metadata of the second configuration file, wherein each symbol in the second set of symbols is associated with another different weight of the shared set of weights.

7. The data processing system of claim 6, wherein the runtime processor is further configured to:
verify that the second number of symbols is equal to the first number of symbols; and
for each symbol in the second set of symbols, associate the symbol with a corresponding symbol in the first set of symbols.

8. The data processing system of claim 7, wherein the runtime processor is further configured to:
raise an error in response to detecting that the second number of symbols is different than the first number of symbols or that one of the symbols in the second set of symbols fails to be associated with a corresponding symbol in the first set of symbols.

9. The data processing system of claim 7, wherein the runtime processor is further configured to:
verify that each symbol in the second set of symbols and the corresponding symbol in the first set of symbols is associated with a same location and a same layout in the memory circuitry.

10. The data processing system of claim 9, wherein the runtime processor is further configured to:
raise an error in response to detecting that one of the symbols in the second set of symbols fails to be associated with a same location and a same layout in the memory circuitry as the corresponding symbol in the first set of symbols.

11. A method of operating a data processing system comprising a runtime processor that is coupled to reconfigurable processor circuits and memory circuitry, comprising:
with the runtime processor, receiving a first configuration file of a first configuration of an application;
with the runtime processor, receiving a second configuration file of a second configuration of the application, wherein the second configuration is different than the first configuration;
configuring first reconfigurable components in the reconfigurable processor circuits according to the first configuration, the first reconfigurable components being configured to:
access the memory circuitry to retrieve a shared set of weights that is stored in the memory circuitry; and
implement a first set of operations that operates on the shared set of weights; and
configuring second reconfigurable components in the reconfigurable processor circuits according to the second configuration, the second reconfigurable components being configured to:
access the memory circuitry to retrieve the shared set of weights, and
implement a second set of operations that operates on the shared set of weights.

12. The method of claim 10, wherein the first configuration file comprises a first bit file and a first argument table, wherein the second configuration file comprises a second bit file and a second argument table, further comprising:
with the reconfigurable processor circuits, loading the first bit file and the first argument table from the memory circuitry;
overriding first predetermined numerical constants in the first bit file with corresponding values from the first argument table, wherein the first predetermined numerical constants in the first bit file comprise at least a first virtual address associated with a physical address in the memory circuitry;
with the reconfigurable processor circuits, loading the second bit file and the second argument table from the memory circuitry; and
overriding second predetermined numerical constants in the second bit file with corresponding values from the second argument table, wherein the second predetermined numerical constants in the second bit file comprise at least a second virtual address associated with the physical address in the memory circuitry, and wherein the memory circuitry stores a weight of the shared set of weights at the physical address.

13. The method of claim 12, wherein the first reconfigurable components comprise first programmable compute units, first programmable memory units, and first programmable interconnections between the first programmable compute units and the first programmable memory units, wherein the second reconfigurable components comprise second programmable compute units, second programmable memory units, and second programmable interconnections between the second programmable compute units and the second programmable memory units, further comprising:
programming first programmable compute units, first programmable memory units, and first programmable interconnections using the first bit file and the first argument table; and
programming second programmable compute units, second programmable memory units, and second programmable interconnections using the second bit file and the second argument table.

14. The method of claim 12, further comprising:
identifying a first set of symbols having a first number of symbols in first metadata of the first configuration file, wherein each symbol in the first set of symbols is associated with a different weight of the shared set of weights; and
identifying a second set of symbols having a second number of symbols in second metadata of the second configuration file, wherein each symbol in the second set of symbols is associated with another different weight of the shared set of weights.

15. The method of claim 14, further comprising:
verifying that the second number of symbols is equal to the first number of symbols; and
for each symbol in the second set of symbols, associating the symbol with a corresponding symbol in the first set of symbols.

16. The method of claim 15, further comprising:
raising an error in response to detecting that the second number of symbols is different than the first number of symbols or that one of the symbols in the second set of symbols fails to be associated with a corresponding symbol in the first set of symbols.

17. The method of claim 15, further comprising:
verifying that each symbol in the second set of symbols and the corresponding symbol in the first set of symbols is associated with a same location and a same layout in the memory circuitry.

18. The method of claim 17, further comprising:
raising an error in response to detecting that one of the symbols in the second set of symbols fails to be associated with a same location and a same layout in the memory circuitry as the corresponding symbol in the first set of symbols.

19. A non-transitory computer-readable storage medium including instructions that, when executed by a processing unit, cause the processing unit to operate a runtime processor, the instructions comprising:
receiving a first configuration file of a first configuration of an application;
receiving a second configuration file of a second configuration of the application, wherein the second configuration is different than the first configuration;
configuring first reconfigurable components in reconfigurable processor circuits according to the first configuration, the first reconfigurable components being configured to:
access memory circuitry that is associated with the reconfigurable processor circuits to retrieve a shared set of weights that is stored in the memory circuitry; and
implement a first set of operations that operates on the shared set of weights; and
configuring second reconfigurable components in the reconfigurable processor circuits according to the second configuration, the second reconfigurable components being configured to:
access the memory circuitry to retrieve the shared set of weights, and
implement a second set of operations that operates on the shared set of weights.

20. The non-transitory computer-readable storage medium of claim 19, wherein the first configuration file comprises a first bit file and a first argument table, wherein the second configuration file comprises a second bit file and a second argument table, and wherein the instructions further comprise:
overriding first predetermined numerical constants in the first bit file with corresponding values from the first argument table to generate an updated first bit file, wherein the first predetermined numerical constants comprise at least a first virtual address associated with a physical address in the memory circuitry, and wherein the memory circuitry stores a weight of the shared set of weights at the physical address;
overriding second predetermined numerical constants in the second bit file with corresponding values from the second argument table to generate an updated second bit file, wherein the second predetermined numerical constants comprise at least a second virtual address associated with the physical address in the memory circuitry;
programming the first reconfigurable components with the updated first bit file; and
programming the second reconfigurable components with the updated second bit file.
